(19) United States
(12) Patent Application Publication
(10) Pub. No.: US 2007/0091160 A1
(43) Pub. Date: Apr. 26, 2007

(54) Apparatus and method for controlling the heaters of a thermal printer head

(76) Inventors: Ludovic Kis, Versailles (FR); Philippe Gautier, Fontenay aux Roses (FR)

Correspondence Address: GLENN PATENT GROUP, 3475 EDISON WAY, SUITE L, MENLO PARK, CA, 94025, US

(21) Appl. No.: 11/256,019

(22) Filed: Oct. 20, 2005

(51) Int. Cl. B41J 2/355; G01D 15/10; H04N 1/024; H05B 1/00

(52) U.S. Cl. 347/180

(57) ABSTRACT

An apparatus and method for the compensation of the effects of residual heat of the resistive heads of a thermal print head is discussed. In photographic applications, the general residual heat pattern through the pass of a page in front of the print head is characterized in advance and is generally unique to each type of printer head. Thereafter compensation is made based on this characteristic. In one embodiment of the invention, data are collected over time and the print head thermal characterization is updated and stored for future use, for example, in a non-volatile memory.

### BACKGROUND OF THE INVENTION

1. Technical Field

The invention relates to a thermal printing system. More particularly, this invention relates to an apparatus and method of controlling the heaters on a thermal print head to compensate for the effects of latent heat.

2. Discussion of the Prior Art

In thermal printing systems, also known as die sublimation printing systems, the print head is comprised of a line of resistive heat-generating elements or heaters mounted on a substrate. Generally, the heaters are placed uniformly and in a single line. The proximity and size of the heaters depends upon the desired resolution. In a typical die sublimation print head, resolutions are in the range of 200 to 600 heaters per inch, corresponding to a resolution of, for example 600 dots-per-inch (dpi) in the later case. The heater may be warmed up by selectively passing an electric current through any one of the desired heaters. The electric current is applied to those heaters where it is desirable to cause a pixel to be thermally transferred on to a printing material such as, for example, a sheet of paper.

A typical printer system 100 is shown with respect to FIG. 1, where a printer controller 110 controls the operation of a die sublimation print head 120, which is comprised of a plurality of heaters positioned to achieve the desired resolution. The print head 120 typically heats a colored ribbon 130, having, for example, the basic colors for printing cyan-magenta-yellow (CMY). The heat applied at the corresponding pixel when the appropriate color is present causes some of the colored material to be transferred to the printed media 140, in a synchronized manner. It is also possible to accomplish a similar result with the use of a heat sensitive printing media. This latter approach saves the use of the ribbon at the expense of using a more costly and generally less stable printing media.

To reach the necessary temperature the heater is heated to a level corresponding to the specific grey level of the desired color. Typically an 8-bit resolution is used for the grey level, i.e. values in the range of 0-255 for each of the printed colors.

Because thermal print heads are physical devices, they tend to have a heat retention, or memory that keeps a certain amount of residual heat on the heater. This residual heat adversely affects the quality of the printed image. The effect of the heat of a single pixel on the heat levels of yet to be printed pixels is schematically shown in FIG. 2. A pixel 210 may impact one or more adjacent pixels of a subsequent line 220, and even a more removed subsequent line 230, and possibly even further lines, naturally in a decreasing manner, assuming no additional current is caused to flow through the respective heater. Therefore, the latent heat that is produced while transferring one line for a specific pixel, has an affect on subsequent lines for that given pixel, and potentially for surrounding pixels. Therefore, the need arises for solutions in which the latent heat effects are compensated to overcome the artifacts introduced by latent heat of a heater. One such solution is provided in U.S. Pat. No. 5,793,403 by Klinefelter where a system and method are shown for the purpose of overcoming such latent thermal effects. In Klinefelter the expected thermal information and compensation therefore is calculated for each pixel in advance of the printing itself, thus creating a thermally compensated image that takes into account the expected latent temperature for the specific image. An inherent disadvantage of the solution is that it is necessary to compute the information for the entire image before printing can commence. Hence, it is also necessary to ensure that there is sufficient memory in the system to support such a solution. Regardless of the amount of printing that is required on the page, the calculation time is essentially identical, and that impacts the overall performance of the system.

Another approach is shown by Spano in U.S. Pat. No. 6,784,909, where one or two previous lines of printing are examined and a predetermined compensation value is provided respective of the pattern of dots. The dot history is provided row-to-row, adjacent dots to the central dot being actuated. One advantage of Spano over Klinefelter is that it is not necessary to pre-calculate the compensation values for each and every dot of the entire page in advance of the beginning of the printing process. However, this system still requires a significant amount of compute power to allow for engine speed printing of a page.

Other solutions provide varying models to more or less accurately adjust the printing level to the specific image at hand.

In view of the limitations of prior art solutions, there is a need for a technique that overcomes the deficiencies of such solutions. Specifically, it would be advantageous to provide a solution that does not require significant amounts of memory and does not require significant compute power. It would be further advantageous if the solution were able to take into account the characteristics of the print head in respect of printing of photographic images.

### SUMMARY OF THE INVENTION

An apparatus and method for the compensation of the effects of residual heat of the resistive heads of a thermal print head is discussed. In photographic applications, the general residual heat pattern through the pass of a page in front of the print head is characterized in advance and is generally unique to each type of printer head. Thereafter compensation is made based on this characteristic. In one embodiment of the invention, data are collected over time and the print head thermal characterization is updated and stored for future use, for example, in a non-volatile memory. In another embodiment, the compensation value is adjusted based on actual data from previous pixels identified as likely to have more significant impact on the heat affecting the performance of a specific pixel of the print head. Based on the compensation data generated, the resistive heaters are driven to ensure the desired photographic characteristics of the printed image.

### BRIEF DESCRIPTION OF THE DRAWINGS

FIG. 1 is schematic diagram showing a thermal printer (prior art);

FIG. 2 is a schematic diagram showing heat propagation from a dot of a thermal printer to future dots to be printed in subsequent lines (prior art);

FIG. 3 is a schematic diagram showing a plurality print lines and corresponding column and row registers;

FIG. 4 is a block schematic diagram showing a print head controller comprising heat-history compensation in accordance with the disclosed invention;

FIG. 5 is a flowchart showing heat compensation in accordance with the disclosed invention;

FIG. 6 is a graph showing the column compensation level in respect of the distance from the start-of-page; and

FIG. 7 is a flowchart showing a static compensation based on the characteristics of a photographic thermal print head.

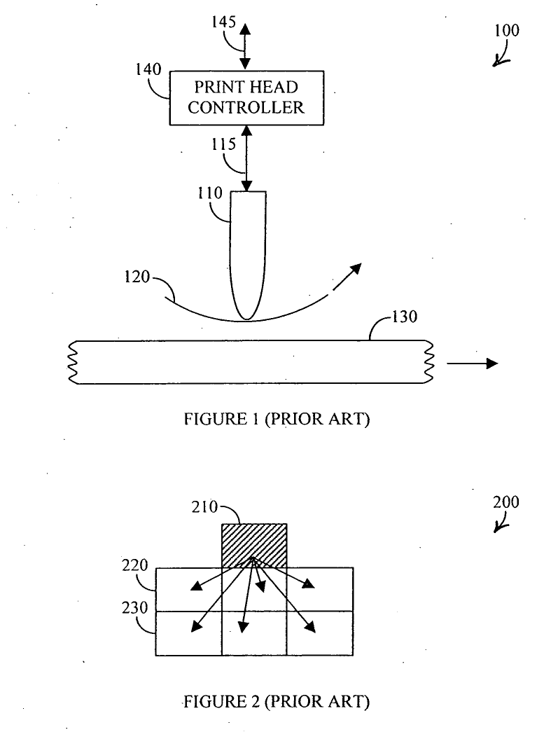

### DETAILED DESCRIPTION OF THE INVENTION

When the primary use of a thermal printer is for printing photographs, certain corrections of the thermal print head drive functions can be achieved using statistical information about the nature of photographic pictures printed by such printers. Specifically, when printing photographic pictures, the thermal history of the thermal print head is generally similar for practically most of the photographic prints used. Therefore, it is possible to use correction solutions which are simpler, faster, and less costly to implement than those shown in prior art. The thermal history characteristics of the thermal print head may be mapped, for example, by checking the thermal history of a plurality of photographs that has already been printed and preparing correction tables containing a plurality of correction values, where each value corresponds to a certain dot printed at a certain line of the image. The correction value is applied whenever necessary. A correction is provided by monitoring the heat history of a row of dots and a column of dots. Then, a specific dot to be printed is corrected by the correction value respective of the specific row and specific column where the next dot to be printed resides by applying the necessary correction to such dot. In one embodiment of the invention, both methods are used to provide more precise results without making the system as complicated as prior art solutions.

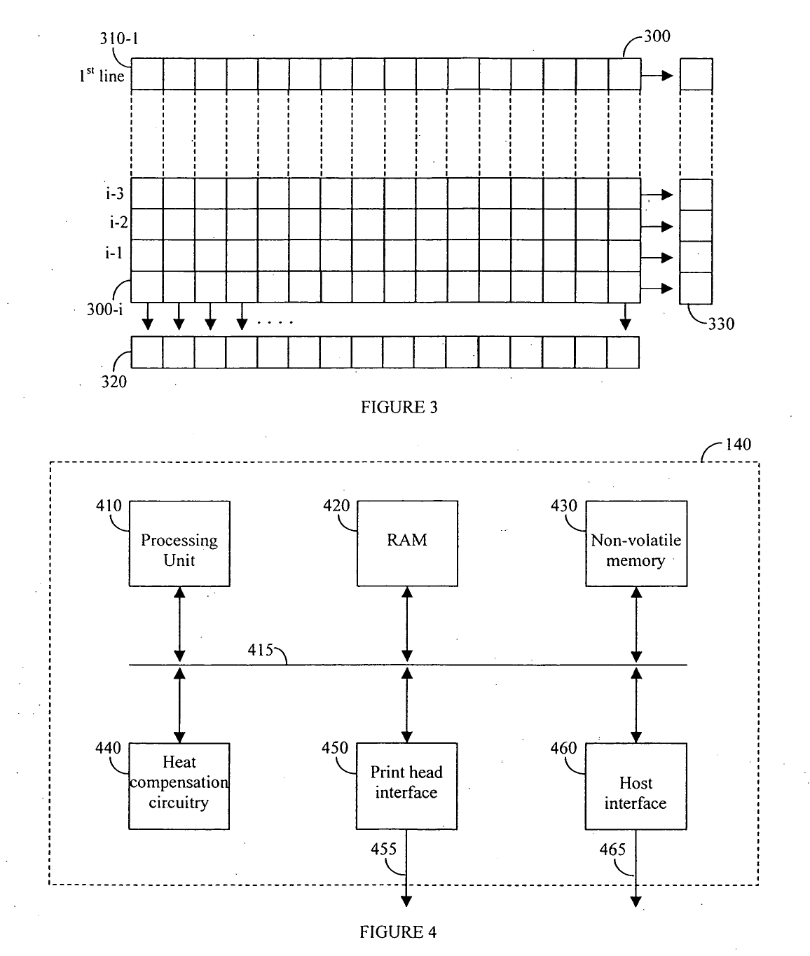

FIG. 3 is a schematic diagram showing an exemplary and non-limiting view of a plurality of printing lines 310, specifically lines 1 through line ‘i’, where each line has a plurality of dots. Each line is printed by a print head, for example the print head shown in FIG. 1. For each column of dots, for example the n-th dot of line 1, the n-th dot of line 2, and so on, until the n-th dot of line ‘i’, the column heat-history value is collected and stored in the n-th register of this register bank 320. Similarly, for a line, for example for line ‘i’, the row heat-history value for the entire line may be collected in a register in the register bank 330. In one embodiment of the invention, a single register comprises the entire register bank 330, i.e. only a single heat-history value is kept. In another embodiment, a plurality of registers the comprise register bank 330, thereby allowing for storage of a plurality of row heat-history values. A column heat-history value may comprise, but is not limited to, an average of the heat collected on a specific dot based on its actual required printing activity. A row heat-history may comprise, but is not limited to, an average of the heat of all the dots in the specific row. It should be noted that no actual measurement on the print head is actually required. Rather, only the actual activation of the specific dot of the print head is tracked because the characteristics of the print head itself may be measured in advance. More details on the compensation process itself are provided below.

FIG. 4 shows an exemplary and non-limiting print head controller circuit 140 that provides the features discussed with respect of FIG. 3 above. A typical printer controller 140 comprises a processing unit 410, a random access memory (RAM) 420, and a non-volatile memory (NVM) 430, each of which are coupled to a communication bus 415. A print head interface 450 is designed to interface with a physical print head, which has the plurality of heating elements that enable the thermal printing process. The print head interface 450 is coupled to the bus 415 and provides a plurality of control and data signals to the print head, for example the print head 110, via the interface signals 115. The print head controller 140 also interfaces with, for example, a host computer by means of a host interface unit 460 that provides data and control signals through the interface 145, and is also coupled to the bus 415. The NVM 430 may comprise, among others, a plurality of executable instructions that cause collection of the heat-history in the manner disclosed herein, as well as heat-history correction tables, as further discussed below. In one embodiment of the invention, a heat compensation circuit 440 is coupled to bus 415 to accelerate certain computation elements, as described herein. The heat compensation circuitry may also comprise register banks 320 and 330. In another embodiment, the register banks 320 and 330 are implemented in a RAM 420.

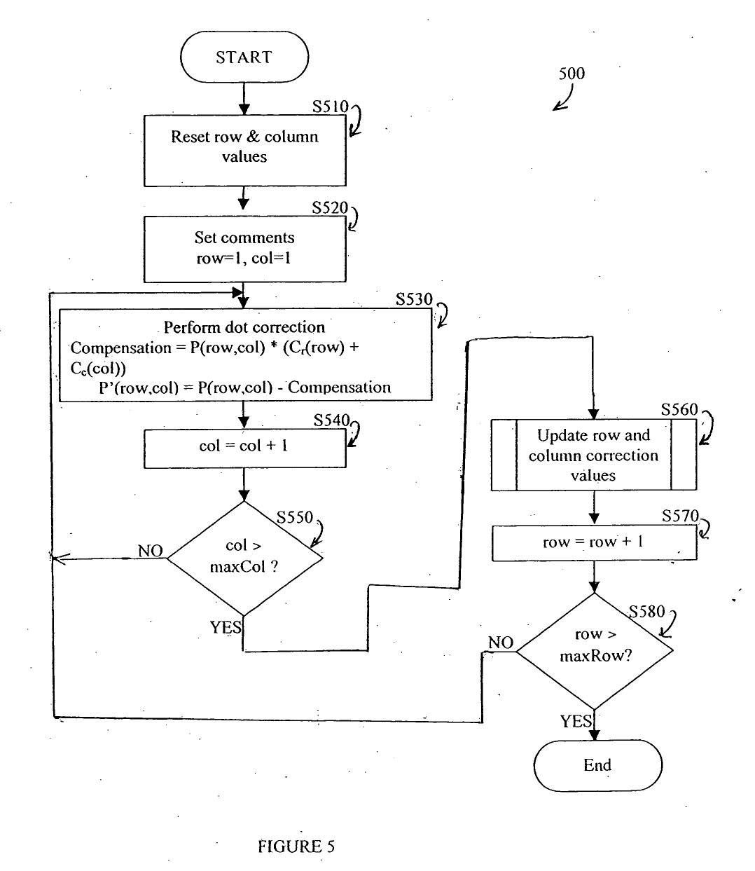

FIG. 5 is an exemplary and non-limiting flowchart 500 which illustrates a method for heat-history compensation in accordance with the invention. In step S510, the register banks 320 and 330 are reset. This operation takes place on a per page basis, because for all practical purposes, the residual heat that is accumulated throughout the printing of a page dissipates during the period in between the printing of two pages. However, it is feasible to add a correction function that takes into account the page-to-page residual heat. In steps S520 and S525, counters that track the row position and the column position within a row are set to an initial value pointing to the first dot, or column, of the first line, or row. In step S530, the value to be provided to the print head for a specific dot in a line is determined based on the stand-alone energy value for the image pixel P(row, col), correction values which are based on the specific row Cr(row), and the specific column, Cc(col), assuming no residual effects present from neighboring pixels. Specifically, the new pixel drive value is:
Compensation=Cr(row)+Cc(col) (1)
P′(row, col)=P(row, col)−Compensation
Because of the heat residue it is necessary to provide less drive to the print head than would otherwise be required if no dots were to be printed other than the specific dot or pixel. The specific correction functions Cr and Cc are, in comparison to prior art solutions, easy to compute on the fly and are dependent on the specific characteristics of the print head. Following the thermal inertia of the print head and implementation constraints, the linear heat compensation in equation (1) may be performed with progressive levels of precision. The correction values act as a weighted correction for the current image pixel P(row,col):
Compensation=P(row, col)*(Cr(row)+Cc(col)) (2)
P′(row, col)=P(row, col)−Compensation

The main difference between equations (1) and (2) is that heat compensation is proportional to image pixel level so it depends locally on the image content. Depending on the computational constraints, the correction functions may be sub-sampled to a reduced grid over the image, resulting in:
Compensation=P(row, col)*(Cr(row*)+Cc(col*)) (3)
P′(row, col)=P(row, col)−Compensation
Where (row*,col*) is the nearest grid point to the current image pixel position (row,col).

In addition, other correction values may also be taken into account, as further detailed below. In step S540, the column counter is advanced to the next column and, in step S550, a determination is made whether the last dot in the line has been reached. If the last dot in the line has been reached execution continues with step S560. Otherwise, execution continues with step S530. In step S560, the correction values are updated based on the information gathered for the current line. The values are used as part of the correction values for the next line to be printed. For example, each register in the register bank 320 receives a new average value, and the current register of register bank 330 receives, for example, the average value for the current row. In such a case, linear heat compensation may be achieved as follows:
Compensation=P(row, col)*(Cr(row)*Dr(row)+Cc(col)*Dc(col)) (4)
P′(row, col)=P(row, col)−Compensation
Where Dr and Dc are generally easy to compute average density functions over a well chosen context around the current image pixel.

In one embodiment of the invention, segments of dots, for example three adjacent dots, are used to create an average, or a weighted average, for a center image pixel, on a per line basis, for determining the specific column average, thereby increasing the accuracy. In one embodiment of the invention, the averaging on a per column basis adds the data from the current line but removes from the average the contribution of an earlier line.

In yet another embodiment a weighted average is combined with linear heat compensation as follows:
Compensation=P(row, col)×(Cr(row)+Cc(col))
P′(row, col)=P(row, col)−Compensation−WeightedAverage (5)
Where WeightedAverage is computed by performing the following sequence:
Init WeightedAverage
For (row*, col*) over Pixel Context Do
   WeightedAverage=WeightedAverage+Weight(row*−row, col*−col)*P(row*, col*)
   and where the weight coefficients are obtained by experiment. The heat compensation context may be chosen according to heat propagation laws.

In step S570 the row counter is incremented to point to the next in turn line; and in step S580, a determination is made whether the maximum number of lines has been reached. If the maximum number of lines has not been reached execution continues with step S525. Otherwise, execution ceases because the page has reached its end.

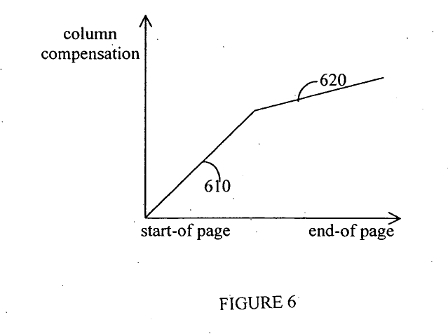

The heat-history correction function for the teachings made herein and, more specifically, for printing from the top to the bottom of the length of the page, have the characteristics shown in FIG. 6. In a typical case, the function behaves as a piecewise linear function. Initially, from the start of page and until a certain number of lines printed, the additional compensation required for the pixel in the column increases. Thereafter, the rate of added compensation for the next pixel in each column is reduced. This is exemplified by the different angle of, for example, lines 610 and 620 in the graph for the column compensation. Line 610 has a steeper angle than line 620, generally indicating that the first pixels of a column printed have a more significant impact on the heat-history of the print head, than that of the subsequent printed pixels of the column.

Yet another aspect of the invention concerns compensation of photographic thermal printed heads, i.e. those print heads intended for use when printing photographs. While for the eye photographs show significant differences, the heat-history, or residual heat, was found to be by the inventors, when checking a plurality of exemplary photographic images, to have a generally similar heat-history profile. Therefore, in accordance with an embodiment of the invention, the compensation function may be based solely on a table stored in an NVM 430, and which requests from a determination of the compensation factor per pixel to be printed, based on testing a large number of photographic images. In another embodiment of the invention, and for the purpose of achieving additional accuracy, the per row and per column compensation discussed above is combined with the pre-determined compensation to provide a more accurate compensation while maintaining the simplicity and performance of the invention.

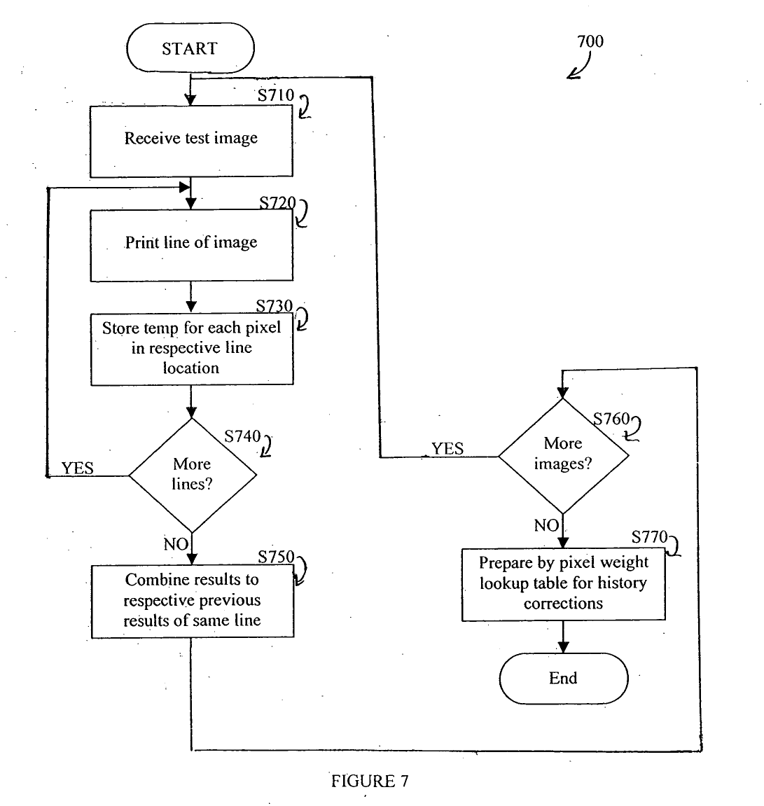

FIG. 7 provides an exemplary and non-limiting flowchart which illustrates the determination of a static heat-history compensation table. In step S710, a test image is received for printing. In step S720, a line of the received image is printed; and in line S730, the residual heat is measured and stored for each dot of the print head, for example the print head 110. In step S740, a determination is made whether additional lines may be printed and, if so, execution continues with step S720. Otherwise, execution continues with step S750. In step S750, the residual values of each dot of the entire matrix printed by the print head are added to the respective dots collected when printing previous images. In one embodiment, the average per dot is calculated. In step S760, a determination is made whether additional images are to be printed and, if so, execution continues with step S710, Otherwise, execution continues with step S770. In step S770, a look-up table is prepared with a compensation value for each dot based on the plurality of test images printed. The look-up table, as noted above, may be stored in the NVM 430. When the look-up table is used in conjunction with the per row and per column compensation, the new pixel drive is calculated as:
Compensation=P(row, col)×(Cr(row)+Cc(col))
P′(row, col)=P(row, col)−Compensation−Ct(row,col) (6)
Where the value Ct(row,col) is provided from the look-up table. If only the look-up table method is used, then the new pixel drive is calculated as:
P′(row, col)=P(row, col)−Ct(row,col) (7)

Hence, no local addition and multiplication are required. Following the image type, an external optimization process concentrates compensation on the construction of the look up table function Ct. Note that the function Ct may be non-separable and non-linear with respect to the position (row, col).

In one embodiment of the invention, a plurality of lookup table are stored for use by the print head. Based on the characteristics of the image to be printed the most appropriate of the compensation lookup tables is used. Following the targeted implementation constraints, equation (6) may be used in combination with linear heat compensation variants described in equations (2), (3), (4), and (5). In another embodiment of the invention, the methods herein are included in a computer software product that contains a plurality of instructions. The plurality of instructions, when executed, implement the methods disclosed herein.

Although the invention is described herein with reference to some preferred embodiments, one skilled in the art will readily appreciate that other applications may be substituted for those set forth herein without departing from the spirit and scope of the present invention. Accordingly, the invention should only be limited by the Claims included below.

1. A method for adjusting an energy level supplied to each dot of a plurality of dots of a thermal print head to effect linear heat compensation, comprising for each image pixel the steps of:
calculating a compensation value for an image pixel, said compensation value comprising a first value respective of the row of said image pixel and a second value for respective of the column of said image pixel;
subtracting said compensation value for said image pixel from a stand-alone heat energy value for said image pixel to produce a compensated heat energy value; and
driving a dot of said plurality of dots with said compensated heat energy value when said dot corresponds to said image pixel column and row.

2. The method of claim 1, further comprising the step of:
extracting said first value from a function that is dependent on a distance of said image pixel from a start-of-line position.

3. The method of claim 1, further comprising the step of:
extracting said second value from a function that is dependent on a distance of said image pixel from a start-of-page position.

4. The method of claim 3, wherein said function comprising a piecewise linear function.

5. The method of claim 1, said step for calculating a compensation value further comprising the step of:
adding said first value and said second value.

6. The method of claim 5, further comprising the step of:
multiplying said compensation value for said image pixel by an amount of heat energy for said image pixel.

7. The method of claim 1, further comprising the steps of:
multiplying said first value by a row average density function; and
multiplying said second value by a column average density function.

8. The method of claim 7, wherein each of said row average density function and said column average density function are within a predefined proximity of said image pixel.

9. The method of claim 1, further comprising the step of:
subtracting a weighted average within a predefined proximity of said image pixel from the stand-alone heat energy value for said image pixel.

10. The method of claim 9, wherein said weighted average function has an impact on said image pixel of a column farther from said image pixel that is less than an impact on a column that is closer to said image pixel.

11. The method of claim 9, wherein said weighted average function has an impact on said image pixel of a row farther from said image pixel that is less than an impact by a row that is closer to said image pixel.

12. The method of claim 1, further comprising the step of:
subtracting a compensation value in a look-up table from the stand-alone heat energy value for said image pixel.

13. The method of claim 12, said look-up table comprising a compensation value for each pixel of an image.

14. The method of claim 13, further comprising the step of:
selecting a look-up table that is pertinent to an image to be printed from a plurality of look-up tables.

15. A computer software product containing a plurality of instructions, the plurality of instructions when executed implementing the method of claim 1.

16. An apparatus for adjusting an energy level supplied to each dot of a plurality of dots comprising a thermal print head to effect linear heat compensation, comprising:
means for calculating a compensation value for an image pixel, said compensation value comprising a first value respective of said image pixel's row and a second value respective of said image pixel's column;
means for subtracting said image pixel to provide a compensated heat energy value from the stand-alone heat energy value for said image pixel said compensation value for; and
means for driving a dot of said plurality of dots with said compensated heat energy value when said dot corresponds to said image pixel column and row.

17. The apparatus of claim 16, further comprising:
means for extracting said first value from a piecewise linear function that is dependent on a horizontal distance of said image pixel from a left margin of a print page.

18. The apparatus of claim 16, further comprising:
means for extracting said second value from a piecewise linear function dependent on the vertical distance of said image pixel from the top margin of a print page.

19. The apparatus of claim 16, further comprising:
means for adding said first value and said second value.

20. The apparatus of claim 19, further comprises:
means for multiplying said compensation value for said image pixel by an amount of heat energy for said image pixel.

21. The apparatus of claim 16, further comprising:
means for multiplying said first value by a row average density function; and
means for multiplying said second value by a column average density function.

22. The apparatus of claim 21, wherein each of said row average density function and said column average density function are within a predefined proximity to said image pixel.

23. The apparatus of claim 16, further comprising:
means for subtracting a weighted average within a predefined proximity of said image pixel from a stand-alone heat energy for said image pixel.

24. The apparatus of claim 23, wherein said weighted average function has an on said image pixel for a column that is farther from said image pixel that is less than an impact on a column that is closer to said image pixel.

25. The apparatus of claim 23, wherein said weighted average function has an impact on said image pixel for a row that is farther from said image pixel that is less than an impact on a row that is closer to said image pixel.

26. The apparatus of claim 16, further comprising:
means for subtracting a compensation value in a look-up table from the stand-alone heat energy value for said image pixel.

27. The apparatus of claim 26, said look-up table comprising a compensation value for each pixel of an image.

28. The apparatus of claim 26, further comprising:
a plurality of look-up tables, each of said look-up tables being pertinent to a particular type of image to be printed; and
means for selecting a look-up table from said plurality of look-up tables, that is pertinent to an image to be printed.

29. A method for adjusting an energy level supplied to each dot of a plurality of dots of a thermal print head to effect linear heat compensation, comprising for each image pixel the steps of:
extracting a compensation value for said image pixel from a location in a look-up table corresponding to said image pixel location in a page;
subtracting said compensation value for said image pixel from the stand-alone heat energy value for said image pixel; and
driving a dot of said plurality of dots with said compensated heat energy value when such dot corresponds to said image pixel column and row.

30. The method of claim 29, said look-up table comprising a compensation value for each pixel of an image.

31. The method of claim 30, further comprising the step of:
selecting a look-up table that is pertinent to an image to be printed from a plurality of look-up tables.

32. A computer software product containing a plurality of instructions, the plurality of instructions when executed implementing the method of claim 29.

33. An apparatus for adjusting an energy level supplied to each dot of a plurality of dots comprising a thermal print head to effect linear heat compensation, comprising:
means for extracting a compensation value for said image pixel from a location in a look-up table corresponding to said image pixel location in a page;
means for subtracting said compensation value for said image pixel from the stand-alone heat energy value for said image pixel; and
means for driving a dot of said plurality of dots with said compensated heat energy value when such dot corresponds to said image pixel column and row.

34. The apparatus of claim 33, said look-up table comprising a compensation value for each pixel of an image.

35. The apparatus of claim 34, further comprising:
means for selecting a look-up table that is pertinent to the image to be printed from a plurality of look-up table.

36. A method for generating a lookup table containing heat-history compensation values for a thermal print head, the compensation values determined by performing the steps of:
receiving an image to be printed;
storing for each printed line of said image a residual heat value for each dot of said print head;
combining said residual heat value for each dot with a value obtained for each respective dot in a previous image printed using said print head; and
generating a lookup table containing a plurality of expected heat-history compensation values for each pixel of an image page to be printed by said print head.

37. The method of claim 36, said step of combining further comprising the step of:
determining an average residual heat value for each dot.

38. A computer software product containing a plurality of instructions, the plurality of instructions when executed implementing the method of claim 35.
